(19) United States
(12) Patent Application Publication
(10) Pub. No.: US 2025/0085205 A1
(43) Pub. Date: Mar. 13, 2025

(54) METHOD AND SYSTEM FOR MEASURING THE KINEMATIC VISCOSITY OF A FREE FLUID STREAM

(71) Applicant: SAINT-GOBAIN ISOVER, COURBEVOIE (FR)

(72) Inventors: Eric JANIAUD, AUBERVILLIERS (FR); Frédéric ZAMI-PIERRE, CHARNY OREE DE PUISAYE (FR); Ezzeddine OUERGHEMMI, COURBEVOIE (FR); Guillaume BARBA ROSSA, COURBEVOIE (FR)

(21) Appl. No.: 18/720,417

(22) PCT Filed: Dec. 16, 2022
(86) PCT No.: PCT/EP2022/086258

§ 371 Date: Jun. 14, 2024

(30) Foreign Application Priority Data
Dec. 17, 2021 (EP) EP21215695

(51) Int. Cl. G01N 11/04; G01F 1/00; G01N 11/00

(52) U.S. Cl. CPC G01N 11/04; G01F 1/00; G01N 2011/008

(57) ABSTRACT

A computer implemented method for measuring the viscosity of a fluid stream flowing from an opening with constant acceleration, wherein the method takes as input at least one image of an area of interest of a fluid stream, the section, s₀, of the opening and the output volume flow rate, U₀, of the fluid stream from said opening; wherein the method provides as output the viscosity, η, of the fluid; wherein the method includes (a) modelling the geometrical profile of the fluid stream trough an digital processing operation of the input image, and (b) computing the viscosity of the fluid with a mathematical or physical model from the modelled geometrical profile, the section, s₀, and the output volume flow rate, U₀.

### TECHNICAL FIELD

The present disclosure pertains to methods for determining the viscosity of a free fluid stream under industrial environments, in particular in industrial processes for glass manufacturing, more specifically for the manufacturing of mineral glass fibres-based materials, e.g., mineral wool such as glasswool or stonewool.

### TECHNICAL BACKGROUND

Within manufacturing lines of mineral wool, the molten glass coming from glass melting furnaces is carried through a forehearth to feed a fiberizing tool. From the forehearth to the fiberizing tool the molten glass flows through what is called a bushing. The bushing is generally designed as an opening extended by a nozzle or drain pan and terminated by a hole from which the molten glass flows by gravity. Depending on its size and diameter, the bushing controls the flow rate of the molten glass into the fiberizing tool.

A fiberizing tool usually comprises a high-speed rotating device, called a centrifuge, a spinner, or a spinning plate, which is made of an annular wall through which calibrated holes have been drilled. Upon feeding with the molten glass coming out of the bushing, the high-speed rotating device projects the molten glass through the drilled holes to cast glass threads.

The fiberizing tool also comprises a ring or annular burner which throws an elevated temperature gaseous stream or jet in a substantially tangent direction to the annular wall to pull down the casted glass threads. The pulling stream or jet also allows to heat and stretch the glass threads and form glass fibres.

One requirement to obtain a high-quality product, e.g., stone or glass wool, is that the glass threads should be properly stretched while they are casted out and pulled down from the rotating device. The pulling and stretching operation should not be too intense or too fast to avoid their breakage while allowing sufficiently elongated glass fibres to be formed. Otherwise, the final product, e.g., stone or glass wool, no longer fulfils the technical requirements regarding, for instance, thickness and insulation performances. The product must be discarded, resulting in financial losses for the manufacturers.

As the flow rate of a molten glass depends on its temperature and its chemistry, it is then a current practice to punctually take samples of molten glass before the bushing and to perform chemical analysis. It is also a widespread practice to punctually measure or continuously monitor the temperature of the molten glass in the vicinity of the bushing, e.g., just before, after, or inside.

On short term basis, the flow rate of a molten glass during the pulling and stretching operation may be controlled by changing its temperature in the vicinity of the bushing. The temperature adjustment may be performed through an adapted heating operation, e.g., Joule heating through flowing an electric current in a metallic bushing. On a longterm basis, the chemistry of the melted glass may also be changed by adapting the chemistry of the raw materials on the melting process.

WO 8304437 A1 [GULLFIBER AB [SE]] 22.12.1983 discloses a method for measuring the flow velocity of a freely falling stream of molten glass. The method relies on the measurement of time interval between pulse-like signals generated by inhomogeneity within the stream and detected by two separated radiation detectors.

U.S. Pat. No. 4,877,436 A [SHEINKOP ISAC [US]] 31.10.1989 discloses a method for controlling the flow rate and the viscosity of molten glass during production. The method relies on the calculation of the viscosity of the molten glass with the Hagen-Poiseuille law for which a prior knowledge of the density of the molten glass is required.

U.S. Pat. No. 5,170,438 A [GRAHAM FIBER GLASS LTD [CA]] 08.12.1992 discloses an apparatus for determining the volumetric flow rate of a viscous fluid stream, such as a molten glass stream. The apparatus performs a digital processing of images of a fluid stream to measure its width from which a flow rate is then calculated upon geometric considerations about the shape of the fluid stream and the foreknowledge of both the velocity and the density of the fluid.

### SUMMARY OF THE INVENTION

### Technical Problem

Changing the temperature of the molten glass in the vicinity of the bushing may be a preferred operation when the flow rate needs to be rapidly adjusted. However, for assessing whether the temperature should be increased or decreased, the actual viscosity or flow rate of the molten glass may first need to be evaluated.

A widespread practice to evaluate the viscosity or the flow rate of a molten glass is to rely on assumption of constant glass density and/or constant viscosity such as in the Hagen-Poiseuille law. The density of a molten glass depending on both its chemistry and temperature, had assumption been made on the chemistry of the molten glass or had been measured, density would likely be evaluated from a measurement of temperature in the vicinity of bushing.

Measuring the temperature of a molten glass in the vicinity of the bushing may be a difficult operation. Because of elevated temperatures and the lack of access, the measurement is generally performed with by optical methods based on black body radiations, e.g., pyrometers. However, this kind of measurement may be overly sensitive to the acquiring conditions, e.g., surface radiation of the molten glass, emissivity of the surface, optical reflection of the surrounding environment . . . and, as the molten glass may be inhomogeneous in temperature, the measure may be very imprecise and may vary depending on the acquisition zone of the molten glass. The value for density may be unreliable and density-viscosity or flow rate relationships such as the Hagen-Poiseuille law may fail or provide unrealistic values for viscosity of flow rate.

Beside these drawbacks, another inconvenient that current viscosity-flow rate relationships, in particular those based on the Hagen-Poiseuille law, is that they require a laminar flow and a uniform viscosity and/or a uniform density in a bushing whose geometry must be simple. Indeed, the Hagen-Poiseuille law is only valid for fluids with laminar flow through a tube or pipe, i.e. fluids with no free surfaces.

However, it is a widespread practice to heat the bushing by Joule effect. This operation may generate spatially and temporally temperature gradients within the molten glass, which in turn generate spatial and temporal variations of the viscosity of the molten glass. Changes in the flow regime, e.g., pressure drops, of the molten glass may occur in the vicinity of the bushing; Viscosity-flow rate relationships may not apply or provide unrealistic values for viscosity.

It is also worth mentioning that the Hagen-Poiseuille law because they require a laminar flow and a uniform viscosity and/or a uniform density in a bushing with a simple geometry, as previously explained, does not apply on free-flowing fluids, i.e., flowing fluids with free surfaces which are not bounded by a tube, pipe, or the like.

Maybe one of the worst negative consequences of the aforementioned issues is that they may lead to a wrong adjustment of the temperature of the molten glass, which, in turn, may cause insidious damages to the manufacturing tools. For instance, a too much increase in temperature may decrease the lifetime of the fiberizing tool.

There is clearly a need for a method for measuring the viscosity of a fluid stream which, in particular, may not rely on a measurement of the temperature of said fluid and may overcome the limitations of current prior art, mainly those based on density-viscosity or flow rate relationships such as the Hagen-Poiseuille law. The method may ideally allow an online, quick and reliable measurement which may be in turn used for real-time adjustment of manufacturing processes.

### Solution to the Technical Problem

In a first aspect of the disclosure, there is provided two alternative computer implemented methods for measuring the kinematic viscosity of a fluid stream as described in claim 1 and in claim 2, dependent claims being advantageous embodiments.

In a second aspect of the disclosure, there is provided a data processing device, a computer program and a computer-readable medium to implement the method of the first aspect.

In a third aspect of the disclosure, there is provided a process for measuring the kinematic viscosity of a fluid stream.

In a fourth aspect of the disclosure, there is provided a system for measuring the kinematic viscosity of a fluid stream.

The method, the process, the data processing device and the system according to the first, second, third and fourth aspect of the disclosure may be used in manufacturing process or installation of glass fibres.

### Advantages of the Invention

A first outstanding advantage of the invention is that the viscosity of a fluid stream may be quickly measured without relying on a measurement of the temperature of the fluid while overcoming the limitations of current prior art, mainly those based on the use of density-viscosity or flow rate relationships.

A second outstanding advantage of the invention is that the viscosity of a fluid stream is measured contactless. A continuous monitoring of the viscosity of the fluid stream is allowed without disturbing or disrupting it, which may save time and costs in manufacturing processes of products such as glass fibres-based products.

A third advantage of the invention is that it can be easily implemented in existing manufacturing lines provided that the configuration of manufacturing lines allows the use of an image recording device for acquiring image of the fluid stream.

### BRIEF DESCRIPTION OF DRAWINGS

FIG. 1 is a schematic representation of an example of manufacturing line of glass fibres.

FIG. 2 is a schematic cross section representation of example of a bushing and a fiberizing tool from a detail I of the [FIG. 1].

FIG. 3 is a schematic representation of a detail II of the [FIG. 2].

FIG. 4 is a data flow diagram of a computer implemented method according to one embodiment of the first aspect of the invention.

FIG. 5 is a data flow diagram of a computer implemented method according to second embodiment of the first aspect of the invention.

FIG. 6 is a data flow diagram of a computer implemented method according to an embodiment of the first aspect of the invention.

FIG. 7 is a plot of geometrical profiles of a fluid stream for an output volume flow rate U₀, 6.3 m³/day, at a section so of 4.5 cm² and for values of kinematic viscosity varying from 87 to 614 Stokes.

FIG. 8 is a plot of geometrical profiles of a fluid stream for an output volume flow rate U₀, 8.4 m³/day, at a section so of 4.5 cm² and for values of kinematic viscosity varying from 87 to 614 Stokes.

FIG. 9 is a plot of geometrical profiles of a fluid stream for an output volume flow rate U₀, 9.6 m³/day, at a section so of 4.5 cm² and for values of kinematic viscosity varying from 87 to 614 Stokes.

FIG. 10 is a plot of geometrical profiles of a fluid stream for an output volume flow rate U₀, 6.3 m³/day, at a section so of 8 cm² and for values of kinematic viscosity varying from 87 to 614 Stokes.

FIG. 11 is a plot of geometrical profiles of a fluid stream for an output volume flow rate U₀, 8.4 m³/day, at a section so of 8 cm² and for values of kinematic viscosity varying from 87 to 614 Stokes.

FIG. 12 is a plot of geometrical profiles of a fluid stream for an output volume flow rate U₀, 9.6 m³/day, at a section so of 8 cm² and for values of kinematic viscosity varying from 87 to 614 Stokes.

FIG. 13 is a plot of velocity flow profiles of a fluid stream for an output volume flow rate U₀, 6.3 m³/day, at a section so of 4.5 cm² and for values of kinematic viscosity varying from 87 to 614 Stokes.

FIG. 14 is a plot of velocity flow profiles of a fluid stream for an output volume flow rate U₀, 8.4 m³/day, at a section so of 4.5 cm² and for values of kinematic viscosity varying from 87 to 614 Stokes.

FIG. 15 is a plot of velocity flow profiles of a fluid stream for an output volume flow rate U₀, 9.6 m³/day, at a section so of 4.5 cm² and for values of kinematic viscosity varying from 87 to 614 Stokes.

FIG. 16 is a plot of velocity flow profiles of a fluid stream for an output volume flow rate U₀, 6.3 m³/day, at a section so of 8 cm² and for values of kinematic viscosity varying from 87 to 614 Stokes.

FIG. 17 is a plot of velocity flow profiles of a fluid stream for an output volume flow rate U₀, 8.4 m³/day, at a section so of 8 cm² and for values of kinematic viscosity varying from 87 to 614 Stokes.

FIG. 18 is a plot of velocity flow profiles of fluid stream for an output volume flow rate U₀, 9.6 m³/day, at a section so of 8 cm² and for values of kinematic viscosity varying from 87 to 614 Stokes.

FIG. 19 is a comparison plots of velocity flow profiles of a fluid stream for an output volume flow rate U₀, 9.6 m³/day, at a section so of 5.7 cm² with example experimental data.

FIG. 20 is a comparison plots of velocity flow profiles of a fluid stream for an output volume flow rate U₀, 9.6 m³/day, at a section so of 5.7 cm² with example experimental data.

FIG. 21 is a physical data flow diagram of a processing data system to implement a method according to the first and/or second aspect of the disclosure

FIG. 22 is a schematic representation of a system for measuring the kinematic viscosity of a fluid stream flowing from an opening with constant acceleration.

FIG. 23 is a plot of geometrical profiles of a fluid stream for an output volume flow rate U₀, 6.3 m³/day, at a section so of 4.5 cm² and for values of kinematic viscosity varying from 87 to 614.

FIG. 24 is a plot of geometrical profiles of a fluid stream for an output volume flow rate U₀, 9.6 m³/day, at a section so of 8.0 cm² and for values of kinematic viscosity varying from 87 to 614.

FIG. 25 is a plot of velocity flow profiles of fluid stream for an output volume flow rate U₀, 6.3 m³/day, at a section so of 4.5 cm² and for values of kinematic viscosity varying from 87 to 614 Stokes.

FIG. 26 is a plot of velocity flow profiles of fluid stream for an output volume flow rate U₀, 9.6 m³/day, at a section so of 8 cm² and for values of kinematic viscosity varying from 87 to 614 Stokes.

### DETAILED DESCRIPTION OF EMBODIMENTS

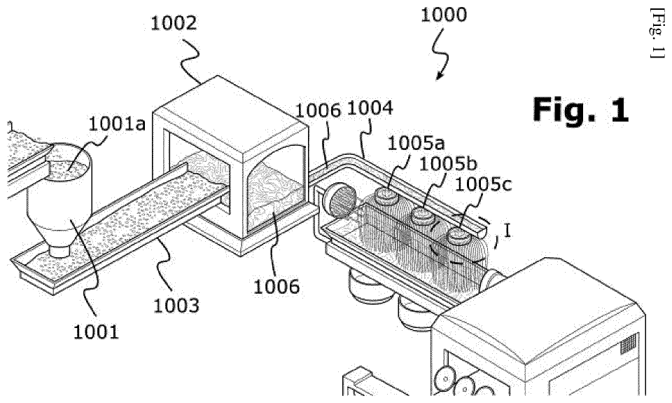

With reference to [FIG. 1], a manufacturing line 1000 of glass fibres may generally comprise silos 1001 for storing raw materials 1001a, e.g., minerals compounds and/or cullet, a glass melting furnace 1002 to melt raw materials 1001a which are conveyed from silos 1001 by means of conveyor 1003, and one or more fiberizing tools 1005a, 1005b, 1005c which are fed with molten glass 1006 through a forehearth 1004. The forehearth is usually designed as an open or closed channel provided with openings right above each fiberizing tools 1005a, 1005b, 1005c to fed each of them with molten glass 1006.

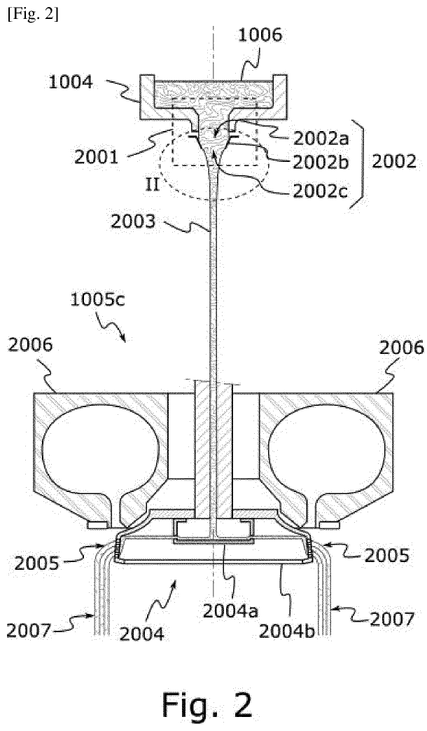

With reference to [FIG. 2], an opening 2001 of a forehearth 1004 may be provided with a bushing 2002 which is here exemplified as an opening 2002a extended by a nozzle or drain pan 2002b and terminated by another opening 2002c from which the molten glass 1006 flows as a fluid stream 2003 by gravity to a fiberizing tool 1005c located beneath. The fiberizing tool 1005c may comprise a spinner 2004 made of bucket 2003a with side openings and of an annular wall 2004b provided with a plurality of calibrated holes. Upon high-speed rotation, the molten glass 1006 coming out of the bushing 2002 as fluid stream 2003 and falling into the bucket 2004a is projected out from its side openings toward the inner surface of the annular wall 2004b, and then projected though the calibrated holes to cast glass threads 2005.

The fiberizing tool 1005c may also comprise a ring burner 2006 that throws out an elevated temperature gaseous stream or jet in a substantially tangent direction to the annular wall to pull down the casted glass threads 2005 in order to heat and strength them and form glass fibres 2007. It may also comprise a gas blowing device 2008 located below the ring burner 2005 to prevent the glass fibres 2007 from departing too far away from the rotation axis of the spinner 2004.

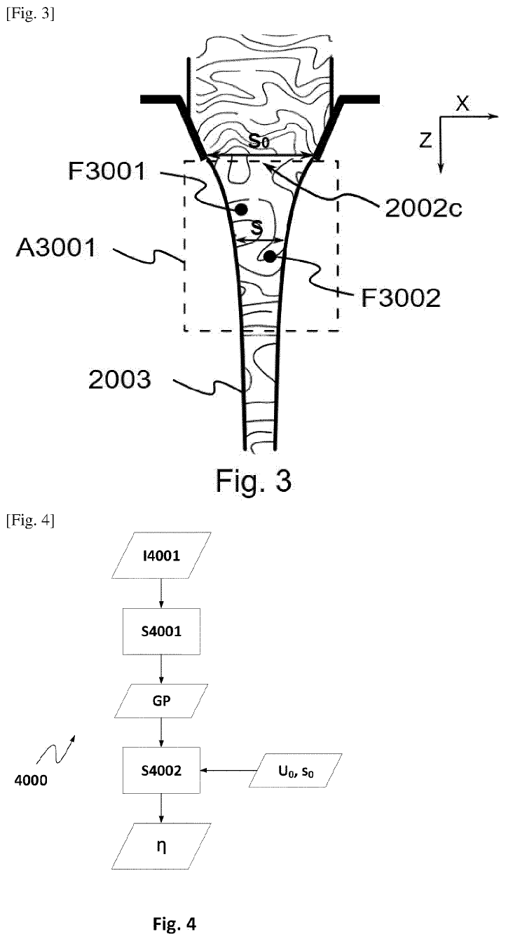

As exemplified on [FIG. 2] and [FIG. 3], when the molten glass 1006 is flowing from the opening 2002c of the bushing 2002 by gravity, it is flowing freely as a free fluid stream 2003 with constant acceleration.

With reference to [FIGS. 3] and 4, in a first aspect of the disclosure, there is provided a computer implemented method 4000 for measuring the kinematic viscosity of a free fluid stream 2003 flowing from an opening 2002c with constant acceleration, wherein said method 4000 takes as input at least one image I4001 of an area A3001 of interest of a fluid stream 2003, the section, s₀, of said opening 2002c and the output volume flow rate, U₀, of the fluid stream 2003 from said opening 2002c;
wherein said method 4000 provides as output the kinematic viscosity, η, of the fluid;
wherein said method 4000 comprises the following steps:
(a) modelling S4001 the geometrical profile GP of the fluid stream 2003 through a digital processing operation of the input image I4001;
(b) computing S4002 the kinematic viscosity of the fluid with a mathematical or physical model from the modelled geometrical profile GP, the section, s₀, and the output volume flow rate, U₀.

In the context of the disclosure, a free fluid stream is to be understand as a free-flowing fluid, i.e., as a flowing fluid with free surfaces which are not bounded by external surfaces such as those from a tube, a pipe, or the like.

In the context of the disclosure, the geometric profile GP should be understood as any dimensional measurement which is representative or allows to derive the variation of the geometric dimensions, e.g., width, section, diameter . . . of the fluid stream 2003 in the flow direction.

In an example embodiment, as illustrated by the reference X, Z axis on [FIG. 3], in a case of a fluid stream with a circular section, the geometric profile may be the variation of the section, the diameter or the radius in the X direction along the flow direction Z. The origin of the X, Z axis may be the opening 2002c.

It may occur that, because of, for instance, the radiation of the fluid stream 2003, e.g., a fluid stream of elevated temperature molten mineral glass, or the industrial surrounding environments of the opening 2002c, that the at least one input image I4001 is marred or spoiled by too much noise which does not allow an accurate modelling of the geometrical profile GP.

Instead of measuring modelling the geometrical profile GP, it may be advantageous to model the flow velocity of the fluid steam 2003, i.e., the velocities of the fluid stream at separate locations of the fluid stream along the flow direction, for instance along the Z direction on [FIG. 3]. This may help to overcome the limitation of a too noisy input image I4001.

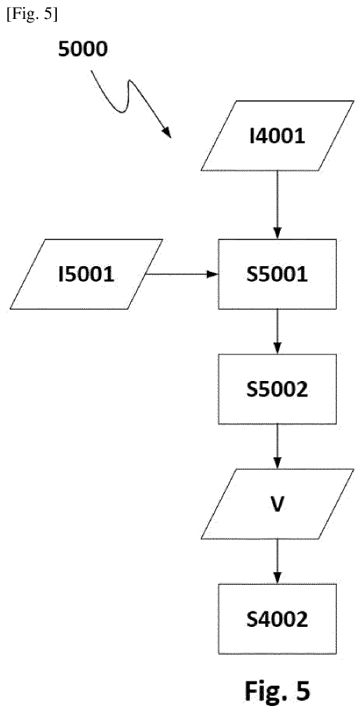

Accordingly, in alternative advantageous embodiments, with reference to [FIG. 3], [FIG. 4] and [FIG. 5], the method 5000 may take as input a first image I4001 of an area A3001 of interest of a fluid stream 2003, the section, s₀, of said opening 2002c and the output volume flow rate, U₀, of the fluid stream 2003 from said opening 2002c, a second time-shifted image I5001 of at least two features F3001, F3002 of the fluid stream 2003, wherein said features F3001, F3002 is present in the first image I4001 provided as input,
wherein said method 5000 provides as output the kinematic viscosity, η, of the fluid;
wherein said method 5000 comprises the following steps:
   digital processing S5001 of the first and second images I4001, I5001 to measure the displacement of said features F3001, F3002;
   computing S5002 the velocities, V1, V2, of each said features F3001, F3002 from the measure of the displacement over the time shift between the first and second images I4001, I5001; and
   computing S4002 the kinematic viscosity of the fluid with a mathematical or physical model from the velocities, V1, V2, the section, s0, and the output volume flow rate, U₀.

The velocities, V1, V2 of the features F3001, F3002, may be viewed as two different measures of the flow velocity, FV, of the fluid stream. In the computing step S4002, each of these two velocities, V1, V2, —may be used independently to compute the value of the kinematic velocity. Such approach, in particular when several velocities are computed from several features within the fluid stream, may advantageously provide better accuracy in the measurement of viscosity.

Advantageously, the more the velocities are computed for the flow velocity FV, the better may be the accuracy of the method. Accordingly, the velocities of a plurality of features, e.g., at least 10 features, preferably at least 50 features, more preferably at least 100 features may be computed. The computation may be performed with much more input images that the two input images I4001, I5001.

The features F3001, F3002 or the plurality of features of the fluid stream 2003 may be any features of the fluid stream 2003 which moves with the fluid stream 2003 and shows certain persistence between the first and second images I4001, I5001 so that their displacement over time may be measured, and thus, their velocity.

In certain embodiments, the at least two features F3001, F3002 may be a defect within the fluid stream 2003. For instance, for molten glass, the defects may be bubbles, non-melted particles, e.g., refractory stones or non-melted raw materials, or other heterogeneities. The defects may be at the surface of the fluid stream or within the bulk. For transparent molten glass, defects within the bulk may be easily detected thanks to the transparency.

The fluid stream 2003 may sometimes show a homogeneous quality and be devoid of visible defect. Artificial defects may be introduced upstream, e.g., with bubbling device in the forehearth for molten glass, or solid particles.

The section, s₀, of the opening 2002c may be either provided as an independent value from the technical specifications of the opening 2002c, or may be measured directly through an image processing of the first image I4001 of the area A3001.

The output volume flow rate, U₀, provided as input may be measured independently from the method according to the first aspect of the invention. For instance, it may be measured automatically with dedicated flowmeters located just beneath the opening 2002c, e.g., with method and an apparatus as described in WO 8304437 A1 [GULLFIBER AB [SE]] 22.12.1983 provided that the section of the fluid stream 3001 may be known or measured. It may also be measured manually from timed sampling.

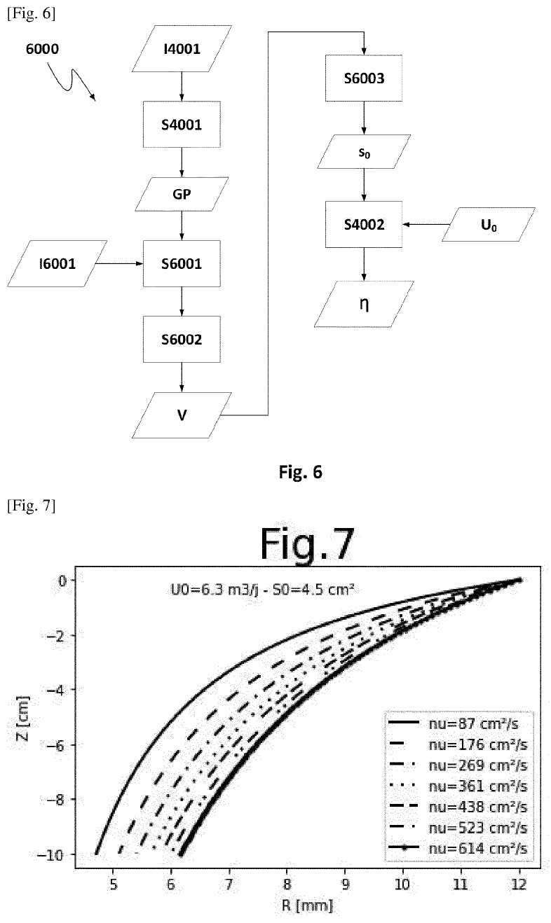

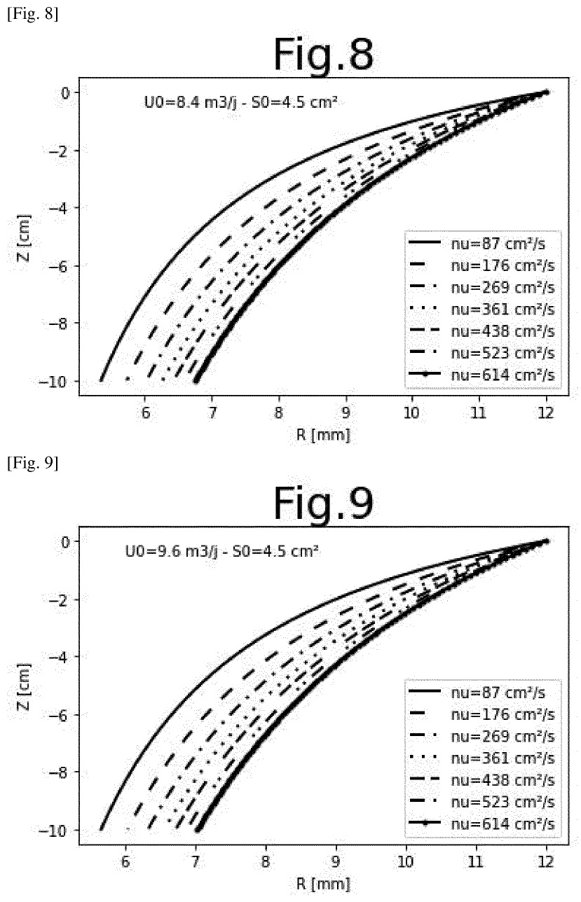

Alternatively, or complementarily, the method according to the first aspect of the disclosure may also be adapted to measure the output volume flow rate, U₀. Accordingly, in one embodiment, with reference to [FIG. 3], [FIG. 4] and [FIG. 6], the method 6000 may further take as input a second time-shifted image I6001 of at least one feature F3001 of the fluid stream 2003, wherein the said feature F3001 is present in the first image I4001 provided as input, and wherein the output volume flow rate, U₀, of the fluid stream 2003 from said opening 2002c is computed after the modelling step S4001 with following steps:
digital processing S6001 of the first and second images I4001, I6001 to measure the displacement of said feature F3001;
computing S6002 the velocity, V, of the feature F3002 from the measure of the displacement over the time shift between the first and second images I4001, I6001;
computing S6003 the output flow rate, U₀, by multiplying the computed velocity, V, by the section, s1, section of the modelled geometrical profile GP of the fluid stream 3001 at the location of the feature F3001 in the first image I6001.

As an illustration, referring to [FIG. 3], the section, s0, of the opening (2002c), is fixed. However, the section, s, of the fluid stream 2003, varies in the Z direction depending on the location of the feature F3001 within the fluid stream 2003 in said Z direction. Thus, the section, s1, of the modelled geometrical profile of the fluid stream 2003 will vary accordingly.

In certain embodiments, to improve the accuracy of the measurement, the output volume flow rate, U₀, may be computed with a plurality of features of the fluid stream 2003 so that to compute a mean output volume flow rate, Umean. The computation may be performed with much more input images that the two input images I4001, I6001.

It may be noteworthy that, according to the law of conservation of mass, the output mass flow rate should not vary in the falling direction, i.e., Z direction, of the fluid stream 2003 in stationary conditions. Therefore, in stationary conditions, which occur in most cases, provided that the temperature, and in turn the density, does not vary or at least at a very limited and negligible extend, the computed output volume flow rate, Umean, is representative measure of the true output volume flow rate, U₀, of the fluid stream 2003 from the opening 2002c.

The feature F3001 may be of the same nature as those discussed above in the context of the alternative embodiments of the [FIG. 5]. Further, when the alternative embodiments of the [FIG. 5] are implemented, steps S6001 and S6002 may be advantageously replaced by steps S5001 and S5002 as they also allow to compute velocities of features of the fluid stream. The input image I6001 may be replaced by the input image I5001. This may limit redundant steps and save time.

The area A3001 of interest may be any area of the fluid stream 2003. Because of the constant acceleration, the fluid stream 2003 may become thinner with distance from the opining 2002c. Thus, it may be advantageous that the fluid stream 2003 shows a certain width for the digital processing operation of steps S4001, S5001, S6001 to work efficiently on the input image I4001, I5001, I6001. Image of thinnest areas of the fluid stream 2003, e.g., the lowest area of the fluid stream, should then be avoided. Practically, the area A3001 of interest may extend from the opening 2002c to a length twice, preferably three times, the diameter of the opening 2002c. The width of the fluid stream in the input image I4001, I5001, I6001 may then be large enough for the digital processing operation.

In the modelling step S4001, the geometric profile GP may be computed with any adapted edge detection algorithm for image processing, e.g., marching square algorithm, canny edge detector, thresholding, edge operators based on Prewitt, Sobel or Scharr filters.

In computing steps S4002, according to certain embodiments, the mathematical or physical model may be experimental and/or simulated relationships, e.g., charts, between geometrical profiles for a fluid stream, its output volume flow rate, its viscosity, and the section of the opening.

As example embodiments, the charts may be derived from earlier experiments in which a substitute fluid, e.g., cold oil, the kinematic viscosity of which may be easily changed is made flow as stream with constant acceleration through openings with different sections at different volume flow rates. The kinematic viscosity may be changed by varying the temperature of the fluid or its composition, e.g., by diluting it in water. Images acquired from several trials conducted with different values for the kinematic viscosity, the opening section and the volume flow rate may allow to construct charts in which a kinematic viscosity value corresponds to a given geometric profile, a given volume flow rate and a given opening section. The data of the charts may be experimental data or model derived from experimental data.

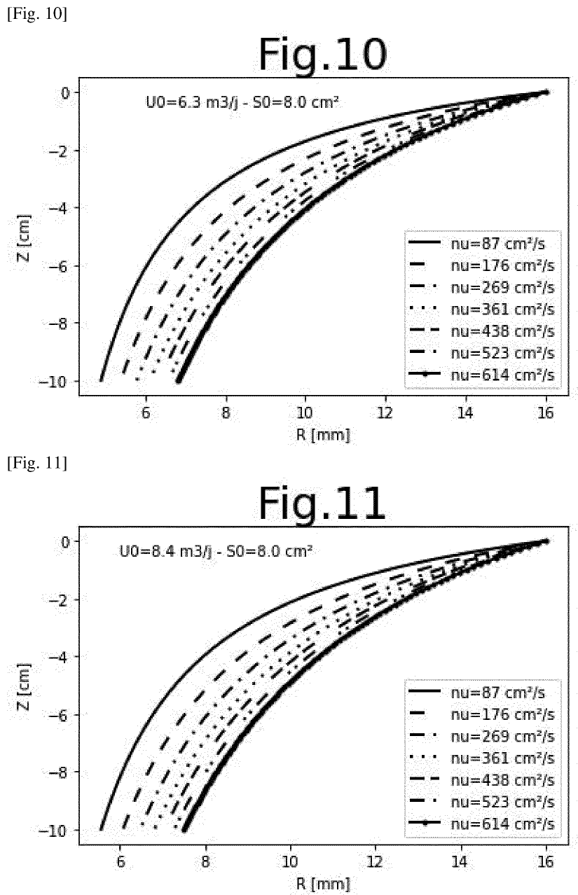

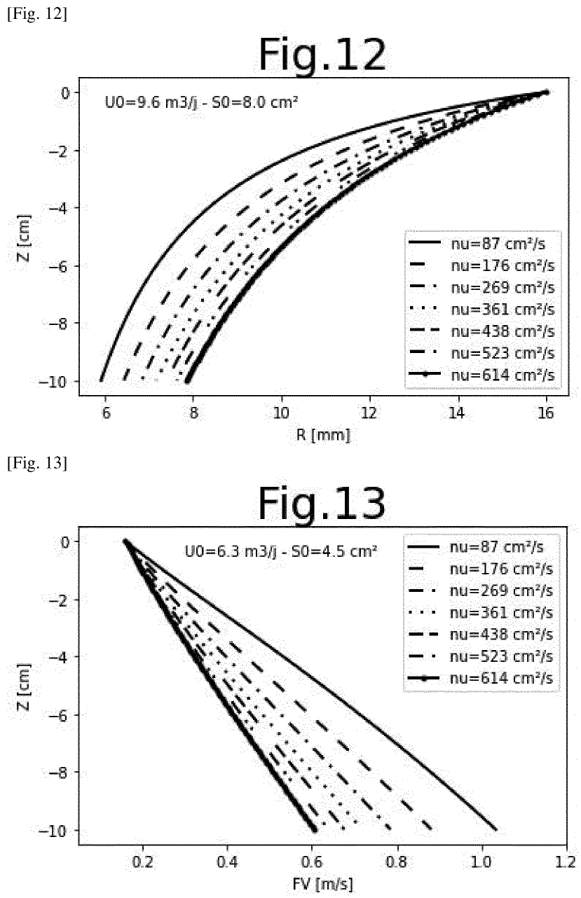

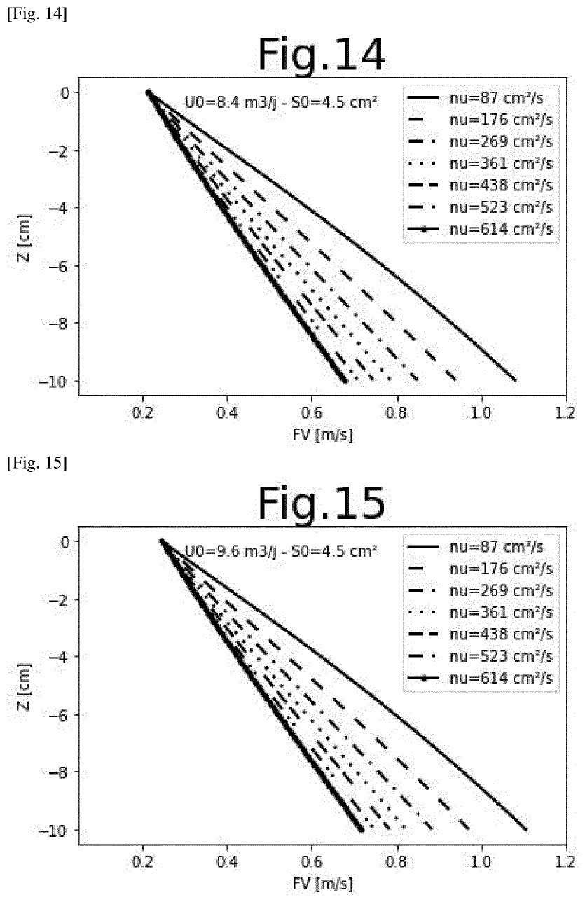

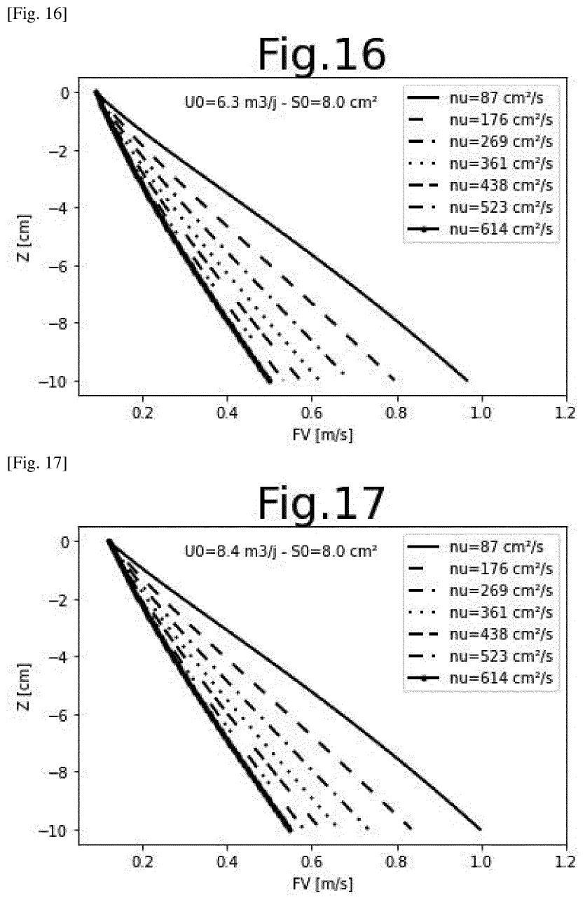

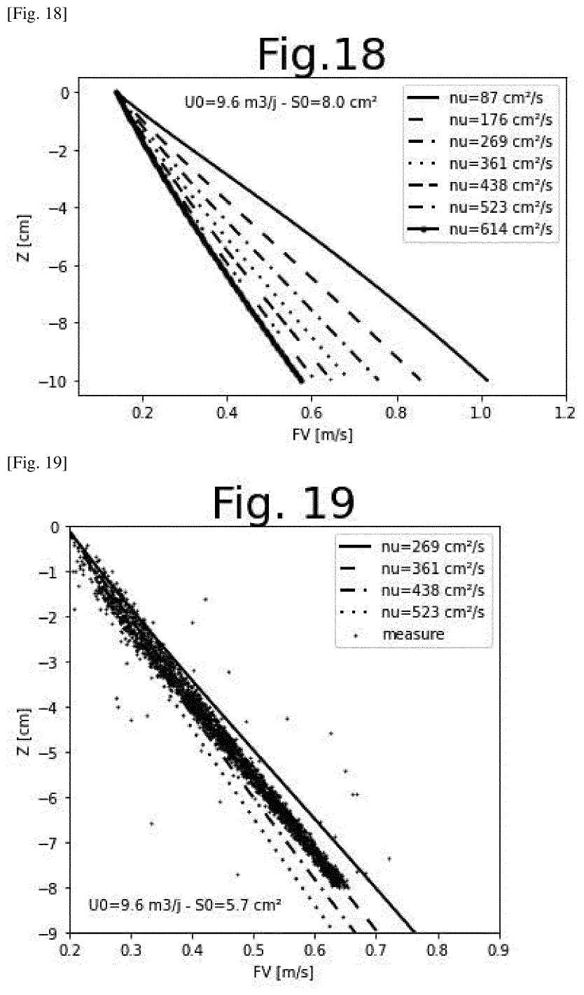

Example charts are provided on [FIG. 7] to 18 for different values of section so of the opening 2002c, different values of the output volume flow rate U₀, and different values of kinematic viscosity.

[FIG. 7] to [FIG. 12] show the geometric profiles of a circular fluid stream represented as an evolution of its radius R in the flow direction Z. [FIG. 7] to [FIG. 9] represent this evolution for three values of output volume flow rate U₀, 6.3 m³/day, 8.4 m³/day and 9.6 m³/day at a section so of 4.5 cm² and for values of kinematic viscosity varying from 87 to 614 Stokes (cm²/s). [FIG. 10] to [FIG. 12] represent this evolution for three values of output volume flow rate U₀, 6.3 m³/day, 8.4 m³/day and 9.6 m³/day, at a section so of 8.0 cm² and for values of kinematic viscosity varying from 87 to 614 Stokes (cm²/s).

[FIG. 13] to [FIG. 18] show the evolution of the flow velocity FV of a fluid stream in the flow direction Z. [FIG. 13] to 15 represent this evolution for three values of output volume flow rate U₀, 6.3 m³/day, 8.4 m³/day and 9.6 m³/day at a section so of 4.5 cm² and for values of kinematic viscosity varying from 87 to 614 Stokes (cm²/s). [FIG. 16] to [FIG. 18] represent this evolution for three values of output volume flow rate U₀, 6.3 m³/day, 8.4 m³/day and 9.6 m³/day, at a section so of 8.0 cm² and for values of kinematic viscosity varying from 87 to 614 Stokes (cm²/s).

In [FIG. 7] to [FIG. 18], the origin for the flow direction Z is the outlet of the opening 2002c.

The values of section so of the opening 2002c, the values of the output volume flow rate U₀, the values of kinematic viscosity, the geometrical profiles and the flow velocity profiles provided on [FIG. 7] to [FIG. 18] are all representative of industrial actual industrial conditions, in particular of a fluid stream of molten glass for the manufacturing glass fibres for glass or stone wool. A person skilled in the art may then directly use these charts for figuring out the kinematic viscosity of fluid stream of molten glass falling in a fiberizing tool. If required, intermediate values may be extrapolated from the data of the [FIG. 7] to [FIG. 18].

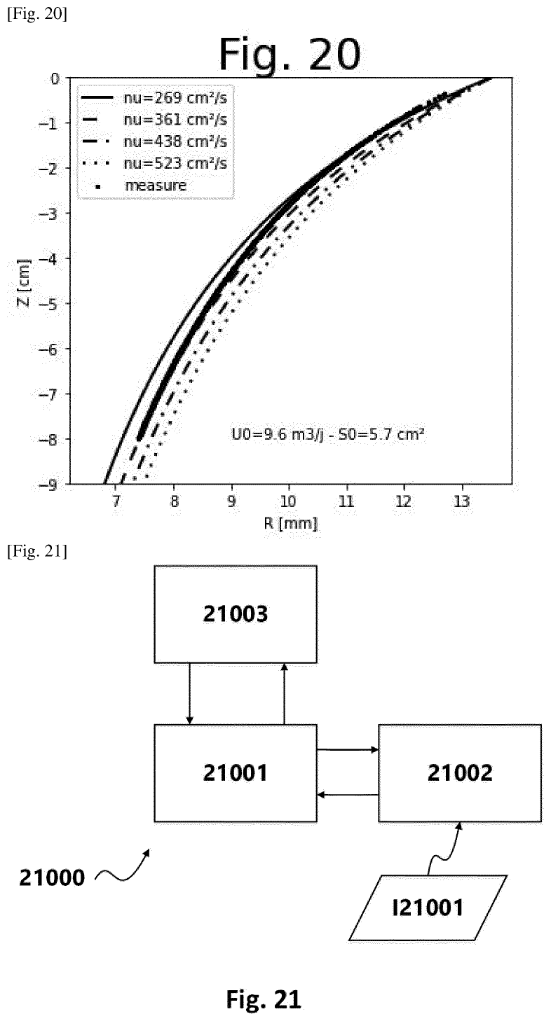

As examples, [FIG. 19] and [FIG. 20] provides respectively a comparison of different velocity flow, FV, and geometric profiles, i.e., radius R of a fluid stream of molten glass with experimental data acquired in industrial conditions for an output volume flow rate U₀, 9.6 m³/day, at a section so of 5.7 cm². Both [FIG. 10] and [FIG. 20] show the almost perfect agreement between the modelled profiles and the experimental data, and demonstrate that the charts according to the disclosure allow an accurate and precise measure of the kinetic viscosity in a fluid stream under industrial environments or conditions.

As other alternative or complementary example embodiments, the mathematical or physical model may be a numerical resolution of the Navier-Stokes equation applied to a freely falling stream of fluid for different conditions, e.g., for different values of the kinematic viscosity, the opening section, and the volume flow rate. Relationships between kinematic viscosity, the opening section, and the volume flow rate may be simulated as geometrical profiles or flow velocity profile and, for instance, represented as charts in which a given kinematic viscosity value corresponds to a given geometric profile or flow velocity profile, a given volume flow rate and a given opening section. Alternatively, the Navier-Stokes equations may be used as a mathematic function to fit, or model, a geometric profile or flow velocity profile of the fluid stream.

As an illustrative example, referring to [FIG. 2] and [FIG. 3], the Navier-Stokes equation applied to a freely falling stream 2003 of fluid from an opening 2002c may be written as follows:

$$\frac{dFV}{dZ} - 3 v \frac{d}{dZ} ( \frac{1}{FV} \frac{dFV}{dZ} ) = \frac{g}{FV}$$

Where v is the kinetic viscosity, so is the section of the opening (2002c), FV is the velocity of the fluid stream (2003), g is the acceleration constant and z is the coordinate in the flow direction Z from the opening 2003, i.e., the vertical direction of the opening.

To numerically solve the above equation, two boundary conditions may be used:

$$FV = \frac{{U}_{0}}{{s}_{0}} \qquad ( 1 )$$

(2) the viscous stress at the end of fluid stream may be neglected, i.e.,

$$v \frac{dFV}{dZ} = 0 ;$$

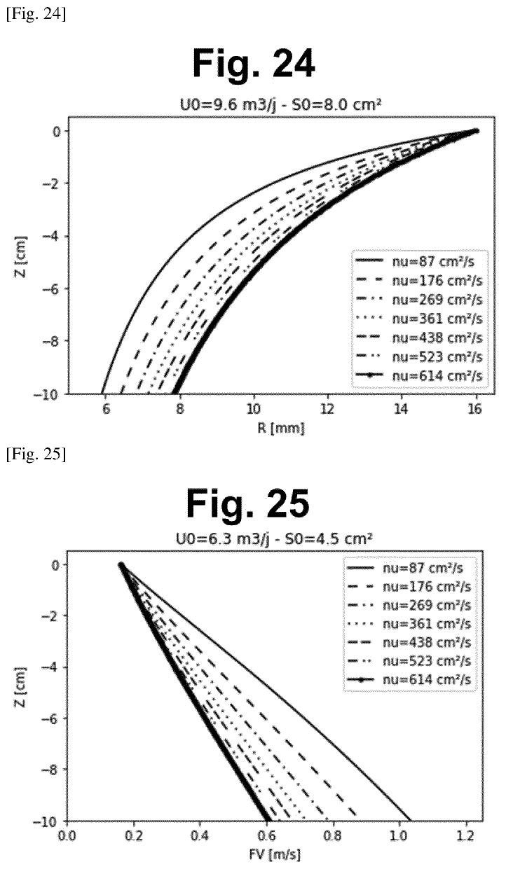

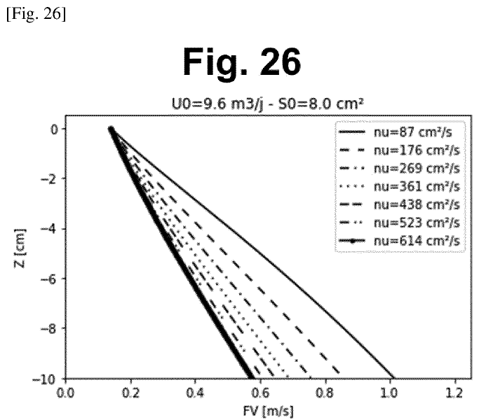

The equation may be solved numerically for different values of the kinetic viscosity, v, of the section, s₀, of the opening 2002c, and of the output volume flow rate, U₀, using a solver for solving boundary value problems, e.g., the bpv_solve solver from the scipy python package.

[FIG. 23] to 24 show the evolution of the flow velocity FV of a fluid stream in the flow direction Z as it may be obtained from such numerical resolution. [FIG. 23] represents this evolution for the output volume flow rate, U₀, 6.3 m³/day with a section s₀ of 4.5 cm² and for values of kinematic viscosity varying from 87 to 614 Stokes (cm²/s). [FIG. 24] represents this evolution for three values of output volume flow rate, U₀, 9.6 m³/day, with a section so of 8.0 cm² and for values of kinematic viscosity varying from 87 to 614 Stokes (cm²/s).

[FIG. 25] to 26 show the same geometric profiles of a circular fluid stream represented as an evolution of its radius R in the flow direction Z, as it may be obtained from the same numerical resolution. [FIG. 25] represents this evolution for three values of output volume flow rate U₀, 6.3 m³/day, with a section so of 4.5 cm² and for values of kinematic viscosity varying from 87 to 614 Stokes (cm²/s). [FIG. 26] represents this evolution for three values of output volume flow rate, U₀, 9.6 m³/day, with a section so of 8.0 cm² and for values of kinematic viscosity varying from 87 to 614 Stokes (cm²/s).

In [FIG. 23] to [FIG. 26], the origin for the flow direction Z is the outlet of the opening 2002c.

In the context of the disclosure, the section of the opening 2002c may have any geometric form which allows a fluid stream 2003 to flow through it. In certain embodiments, the section of the opening 2002c and of the fluid stream 2003 may be circular, as this geometric configuration corresponds to cases in current industrial lines. The section of the opening 2002c may then be computed from its diameter.

In preferred embodiments, the fluid stream 2003 is a stream of molten mineral glass.

In a second aspect of the disclosure, with reference to [FIG. 21], there is provided a data processing system 21000 comprising means 21001 for carrying out a method 4000, 5000, 6000 according to any one of the embodiments of the first aspect of the invention, and a computer program 121001 comprising instructions which, when executed by a computer, cause the computer to carry out a method according to any one of embodiments of the first aspect of the invention.

The data processing system 21000 comprises means 21001 for carrying out a method according to any of the embodiments of the first aspect of the invention. Example of means 21001 may be a device which can be instructed to carry out sequences of arithmetic or logical operations automatically to perform tasks or actions. Such device, also called computer, may comprise one or more Central Processing Unit (CPU) and at least a controller device that are adapted to perform those operations.

It may further comprise other electronic components like input/output interfaces 21003, non-volatile or volatile storage devices 21002, and buses that are communication systems for the data transfer between components inside a computer, or between computers. One of the input/output devices may be user interface for human-machine interaction, for example graphical user interface to display human understandable information.

As calculation may require a lot of computational power to process substantial amounts of data, the data processing system may advantageously comprise one or more Graphical Processing Units (GPU) whose parallel structure makes them more efficient than CPU, in particular for image processing.

The computer program 121001 may be written through any kind of programming language, either compiled or interpreted, to implement the steps of the method according to any embodiments of the first aspect of the invention. The computer program 121001 may be part of a software solution, i.e., part of a collection of executable instructions, code, scripts, or the like and/or databases.

In certain embodiments, there may also be provided a computer-readable storage or medium 21002 comprising instructions which, when executed by a computer, cause the computer to carry out the method according to any of the embodiments of the first aspect of the invention.

The computer-readable storage 21002 may be preferably a non-volatile non-transitory storage or memory, for example hard disk drive or solid-state drive. The computer-readable storage may be removable storage media or a non-removable storage media as part of a computer.

Alternatively, the computer-readable storage may be a volatile memory inside a removable media.

The computer-readable storage 21002 may be part of a computer used as a server from which executable instructions can be downloaded and, when they are executed by a computer, cause the computer to carry out a method according to any of the embodiments described herein.

Alternatively, the program 121001 may be implemented in a distributed computing environment, e.g., cloud computing. The instructions may be executed on the server to which client computers may connect and provide encoded data as inputs to the method. Once data are processed, the output may be downloaded and decoded onto the client computer or directly send, for example, as instructions. This kind of implementation may be advantageous as it can be realised in a distributed computing environment such as a cloud computing solution.

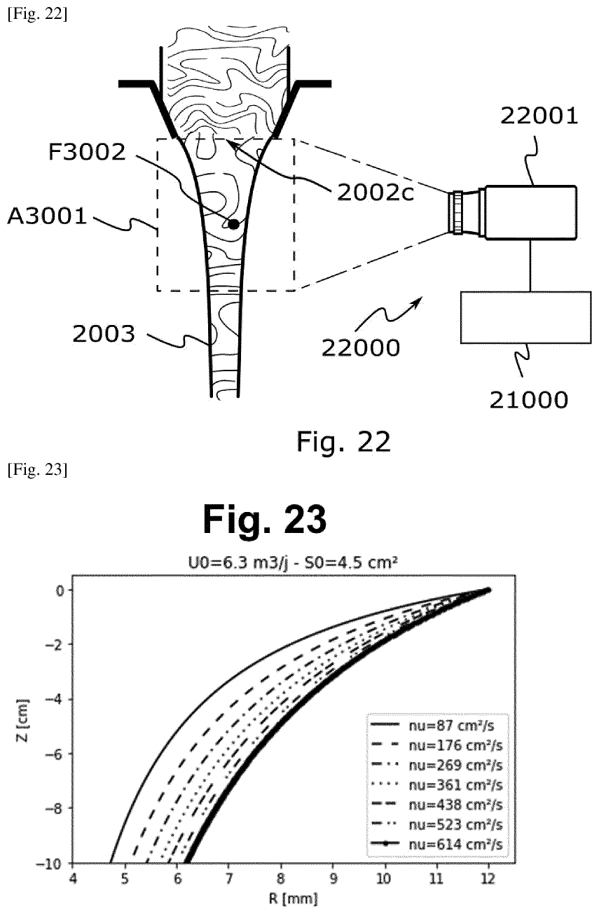

In a third aspect of the disclosure, with reference to [FIG. 3], [FIG. 21] and [FIG. 22], there is provided a process for measuring the kinematic viscosity, η, of a fluid stream 2003 flowing from an 2002c opening with constant acceleration, wherein said process comprises the following steps:
(a) acquiring, with an image recording device 22001, at least one image of an area A3001 of interest of a fluid stream 3001;
(b) modelling, with a data processing mean 21000, the geometrical profile of the fluid stream trough a digital processing operation of the acquired image;
(c) computing, with a data processing mean 21000, the kinematic viscosity, η, of the fluid with a mathematical or physical model from the modelled geometrical profile, the section, s₀, of the opening and the output volume flow rate, U₀, of the fluid stream 3001.

All embodiments described forth in the context of the first aspect of the invention may apply to the process according to the third aspect of the invention. More precisely, all the embodiments on the method 4000, 5000 may be adapted in the process, in particular regarding steps (b) and (c) of said process.

In a fourth aspect of the disclosure, with reference to [FIG. 3], [FIG. 21] and [FIG. 22], there is provided a system 22000 for measuring the kinematic viscosity, η, of a fluid stream 2003 flowing from an opening 2002c with constant acceleration, wherein said system comprises:
a image recording device 22001 configured to acquire at least one image of an area A3001 of interest of a fluid stream 2003;
a data processing device 21000 according to the second aspect of the disclosure and configured to receive images from the image recording device 22001.

In certain embodiments, the image recording device 22001 may be a digital camera, e.g., CCD or CMOS digital camera. The image resolution of the image recording device may depend on the desired precision for measuring the kinematic viscosity. Generally, the smaller the width of the stream fluid 2003, the greater the image resolution.

In advantageous embodiments, the image resolution of digital camera is so that the width resolution of acquired image of the area A3001 of interest of a fluid stream 2003 is at least 200 pixels/cm, preferably at least 400 pixels/cm. These embodiments may suit most of prerequisites of current manufacturing lines.

In preferred embodiments, the digital camera may further be a high-speed digital camera, e.g., a high-speed digital camera with a frame rate of at least 50 frames per second (fps), preferably at least 100 fps. High frame rates may be advantageous to acquire sequences of images which may thereafter be fed to the data processing device 21000. The data processing device 21000 may then be further configured to compute mean or average image of the area A3001 of interest of the fluid stream 2003 from the image of said sequence. The mean image may then be uses to model the geometric profile GP with better accuracy and precision.

High frame rates may also be advantageous to compute the output volume flow rate, U₀, from images of a feature or a plurality of features as described forth in the context of the first aspect of the invention.

As illustrated on [FIG. 22], the image recording device 22001 may be oriented perpendicular to the flow direction of the fluid stream 2003. In certain embodiments, the image recording device 22001 may be oriented or tilted with a certain angle from the flow direction when there is not enough space at proximity of the opening 2002c and the fluid stream for an image recording device 22001 to be placed perpendicular to the flow direction, as it may happen in industrial environment. The tilt angle may be considered when processing the acquired images in order to correct the induced optical deformation within the images.

The distance at which the image recording device 22001 may be placed from the fluid stream 2003 may depend on the focal length, e.g., 50 cm to 1 m, of the device. In certain embodiments, depending on the temperature of the fluid stream 2003, and/or its heat radiation, the image recording device may be placed at a higher distance from the fluid stream to preserve its electronics from heat. A heat shield may also be placed around the camera.

The process, the data processing device and the system according to the second, third and fourth aspects of the disclosure may be advantageously used in a manufacturing line of glass fibres to monitor the kinematic viscosity of a molten glass 1006 flowing through a bushing 2002 by gravity. The manufacturing line may comprise any kind of fiberizing tool, e.g., fiberizing tools comprising a spinner as described earlier or comprising a bottom closed spinner.

In further embodiments, the monitored viscosity may be implemented into a feedback operation for adjusting the temperature of the molten glass 1006 in the vicinity of the bushing 2002.

In this context, in certain embodiments, the system 22000 may further comprise a controller device configured to set or change one or several parameters of one or several components of the manufacturing line which may have an action on the temperature of the molten glass. In some example embodiments, when the kinematic viscosity departs from a set point value, the controller device may act on cooling and/or heating devices related to a forehearth 1004 so that to increase or decrease the temperature of the molten glass before a bushing 2002. In other example embodiments, the controller device may send a visual signal onto a display device to alert a human operator to adjust the chemistry of the molten glass.

All embodiments described herein, whether it concerns the first, second, third or fourth aspect of the invention, may be combined by one skilled in the art unless they appear to him technically incompatible.

Further, although the invention has been described in connection with preferred embodiments, it should be understood that various modifications, additions, and alterations may be made to the invention by one skilled in the art without departing from the spirit and scope of the invention as defined in claims.

1. A computer implemented method for measuring the kinematic viscosity of a free fluid stream flowing from an opening with constant acceleration,
wherein said method takes as input at least one image of an area of interest of a fluid stream, a section, s₀, of said opening and an output volume flow rate, U₀, of the fluid stream from said opening;
wherein said method provides as output a kinematic viscosity, η, of the fluid;
wherein said method comprises the following steps:
(a) modelling the geometrical profile GP of the fluid stream through a digital processing operation of the input image;
(b) computing the kinematic viscosity of the fluid with a mathematical or physical model from the modelled geometrical profile GP, the section, s₀, and the output volume flow rate, U₀.

2. A computer implemented method, wherein said method takes as input a first image of an area of interest of a fluid stream, a section, s₀, of said opening and an output volume flow rate, U₀, of the fluid stream from said opening, a second time-shifted image of at least two features of the fluid stream, wherein said features are present in the first image provided as input,
wherein said method provides as output a kinematic viscosity, η, of the fluid;
wherein said method comprises the following steps:
digital processing of the first and second images to measure a displacement of said features;
computing velocities of each said features from a measure of the displacement over a time shift between the first and second images, and
computing the kinematic viscosity of the fluid with a mathematical or physical model from the velocities, the section, s₀, and the output volume flow rate, U₀.

3. The computer implemented method according to claim 1, wherein said method further takes as input a second time-shifted image of at least one feature of the fluid stream, wherein said feature is present in the first image provided as input, and wherein the output volume flow rate, U₀, of the fluid stream from said opening is computed after the modelling step with following steps:
digital processing of the first and second images to measure the displacement of said feature;
computing a velocity of the feature from a measure of the displacement over the time shift between the first and second images;
computing the output flow rate, U₀, by multiplying the computed velocity by a section, s1, of a modelled geometrical profile GP of the fluid stream at a location of the feature in the first image.

4. The computer implemented method according to claim 3, wherein the output volume flow rate, U₀, is computed with a plurality of features of the fluid stream so that to compute a mean output volume flow rate, Uₘₑₐₙ.

5. The computer implemented method according to claim 3, wherein the features are a defect within the fluid stream.

6. The computer implemented method according to claim 1, wherein a mathematical or physical model is experimental and/or simulated charts of relationships between geometrical profiles for a fluid stream, its output volume flow rate, its viscosity, and the section of the opening.

7. The computer implemented method according to claim 1, wherein a section of the opening and of the fluid stream are circular.

8. A data processing device comprising means for carrying out a method according to claim 1.

9. A computer program comprising instructions which, when the program is executed by a computer, causes the computer to carry out a method according to claim 1.

10. A non-transitory computer-readable medium comprising instructions which, when the instructions are executed by a computer, cause the computer to carry out a method according to claim 1.

11. A process for measuring a kinematic viscosity, η, of a fluid stream flowing from an opening with constant acceleration,
wherein said process comprises the following steps:
(a) acquiring, with an image recording device, at least one image of an area of interest of a fluid stream;
(b) modelling, with a data processing device, a geometrical profile of the fluid stream trough a digital processing operation of the acquired image;
(c) computing, with a data processing device, the kinematic viscosity, η, of the fluid with a mathematical or physical model from the modelled geometrical profile, the section, s₀, of the opening and the output volume flow rate, U₀, of the fluid stream.

12. A system for measuring a kinematic viscosity, η, of a fluid stream flowing from an opening with constant acceleration, wherein said system comprises:
a image recording device configured to acquire at least one image of an area of interest of a fluid stream;
a data processing device according to claim 8 and configured to receive images from the image recording device.

13. A method comprising performing the process according to claim 11 in a manufacturing line of glass fibers to monitor the kinematic viscosity of a molten glass flowing through a bushing by gravity.

14. The method according to claim 13, wherein the monitored kinematic viscosity is implemented into a feedback operation for adjusting the temperature of the molten glass in the vicinity of the bushing.
